(19) United States
(12) Patent Application Publication
(10) Pub. No.: US 2009/0287644 A1
(43) Pub. Date: Nov. 19, 2009

(54) INTERACTIVE RECIPE AND COOKING INFORMATION SYSTEM

(76) Inventor: Lakisha Crosby, Hampton, VA (US)

Correspondence Address: DUNCAN G. BYERS PC, 142 W. York Street, Suite 910, NORFOLK, VA, 23510, US

(21) Appl. No.: 12/120,115

(22) Filed: May 13, 2008

(51) Int. Cl. G06F 17/30

(52) U.S. Cl. 707/3; 707/104.1; 707/E17.014; 707/E17.044

(57) ABSTRACT

An apparatus, method and data structure for providing information related to the preparation of food and beverages. The invention searches available food and beverage information databases based upon search criteria defined by a user. The search criteria may include medical dietary preferences, ingredient and geographic preferences, and the like. The invention provides multiple interface means and means for searching and identifying corresponding recipes based upon user preferences and available ingredients.

### BACKGROUND OF THE PRESENT INVENTION

1. Field of the Invention

This invention relates to an apparatus, method and data structure for providing information related to the preparation of food. More particularly, this invention is related to an apparatus, method and data structure for correlating information regarding food and food preparation in a manner that allows a food preparer to coordinate methods of preparing food with ingredients necessary to prepare specific desired food products.

2. Descriptions of the Prior Art

Grocery lists and the like are well known in the art of cooking. Various sources of information regarding cooking and appropriate lists of ingredients are readily available, generally in book form. However, finding recipes based upon a conjunction of the desired end result (such as a particular type of ethnic food) with the food materials on hand can take a significant amount of time and resources. People have numerous needs that must be addressed when cooking. For example, a person may have particular tastes in food, such as choosing recipes from groups of cooking styles based upon origin of the cooking styles. Such styles might be those commonly identified as Indian, That, French, Caribbean, or other styles of food preparation based upon geographic origin. A person may also have dietary restrictions based upon personal preference or medical necessity. For example, a person may wish to prepare a meal in the style of the American Southwest, but wish to either find vegetarian recipes or information regarding suitable substitutes to create vegetarian dishes from what traditionally would not be vegetarian food. Or, a person may be required to prepare meals in accordance with medical direction and needs, therefore, to modify most, if not all, recipes to accommodate strict dietary requirements.

Generally, a person desiring to create a dish or a meal will consult a recipe book within a specific area (if there is one readily available), find a recipe to their liking, and then determine, based upon the recipe, what ingredients are required. If ingredients are required that the person does not have on hand, the person must either choose a different recipe or expend time, effort, and money buying the necessary ingredients. Further research is required if the person seeks to substitute portions of the ingredients for taste, diet, availability, and/or medical reasons. It is therefore difficult to use currently available material to quickly and efficiently tailor meal plans around the needs of the food preparer (or persons for whom the meal is being prepared) and the available ingredients.

Having a single source that can coordinate desired types of meals with dietary and other requirements, combined with available ingredients is desirable. What is needed, therefore, is a single device or reference source that can be utilized to coordinate tastes with diet, availability of ingredients, and medical needs. Such a device or source should preferentially be portable, and provide numerous options for generating recipes based upon such criteria as taste, diet, available ingredients, and medical needs. The device should also incorporate the ability to be easily updated with new information, as well as providing a user the ability to personalize the device to provide information more closely associated with a user's preferences and needs.

Means and methods for providing cooking support electronically are known in the art. For example, U.S. Pat. No. 7,092,988, issued to Bogatin Aug. 15, 2006, teaches a rapid cooking oven with broadband communication capability. That invention teaches an oven with an integrated programmable controller that utilizes a number of cooking programs to control cooking phases; specifically heat and time parameters for food placed within the oven. That invention also teaches that the oven includes an integrated wireless system to allow access to digital content. The Bogatin invention, however, does not provide capability for interaction between the user and the device to alter recipes. The invention focuses primarily on controlling a stationary cooking source, a high speed oven, wherein the device provides cooking times a control for a set recipe.

U.S. Pat. No. 7,039,589, May 2, 2006 to Whitham, teaches an interactive multimedia book. That device, however, is limited to the extent that the invention does not allow personalization of criteria for determination of what recipes are chosen; the user is limited to a search of existing recipes based upon keywords for the end food product. And, the device does not provide means for determining available recipes based upon certain starting ingredients or alternative ingredients, nor information regarding particular dietary choices or constraints.

The Intelligent Microwave Oven device, U.S. Pat. No. 7,069,091, Jun. 27, 2006 to Williamson teaches a microwave oven with operation of the oven controlled by preset cooking conditions based upon preset recipes associated with particular ingredient codes that are entered into the system. Although the device stores preset recipe information, it simply provides an associated cooking program with particular preset recipe conditions. It does not provide an interactive environment in which a user may choose recipes or alter recipes based upon personal recipe choices, dietary requirements, or specific ingredient requirements.

What is needed, therefore, is a system of providing interactive recipe and cooking information that is tailored to the particular needs and tastes of a user. In particular, there is a need for a system that provides interactive choices regarding particular types and styles of food preparation in accordance with a user's choices, medical and/or dietary requirements, or a set of particular ingredients that a user has as a starting point for recipe choices. The system should provide an interactive database of cooking and recipe information that allows a user to tailor searches and recipes based upon a set of personalized criteria. The system should also provide means for updating and amending the system's cooking information database via external sources, such as world wide web support through various means, including wired and wireless connection. Further, the system should provide for voice interaction so that the user may work in the kitchen without having to physically touch the device, freeing the user's hands for the tasks involved in cooking.

The system will allow a user quick and modifiable information for cooking, such that unskilled individuals can provide tasty and complex meals with little training or experience. The system will provide simple instructions, and allow a user to search for and utilize one or more recipes simultaneously, where those recipes are selected from a recipe database based upon certain user-identified cooking and dietary preferences and/or limitations.

### SUMMARY OF THE INVENTION

It is an object of the present invention to provide an interactive recipe and cooking information system with interactive database.

It is a further object of the present invention to provide an interactive recipe and cooking information system that provides a user with the ability to choose recipes based upon the user's food style preferences.

It is a further object of the present invention to provide an interactive recipe and cooking information system that provides a user with the ability to choose recipes based upon the user's dietary or medical desires and/or requirements.

It is a further object of the present invention to provide an interactive recipe and cooking information system that provides a user with the ability to choose recipes based upon starting ingredients.

It is a further object of the present invention to provide an interactive recipe and cooking information system that provides a user with the ability to choose recipes based upon cultural and/or geographic food and beverage styles and tastes.

It is a set of further object of the present invention to provide a interactive recipe and cooking information system whose database may be updated through various means, including world wide web support through wired or wireless means.

It is a further object of the present invention to provide a interactive recipe and cooking information system that provides requested information in a visual display format.

It is a further object of the present invention to provide a interactive recipe and cooking information system with a user interface through a integrated keyboard or keypad.

It is a further object of the present invention to provide a interactive recipe and cooking information system with a user interface through a touch-screen.

It is a further object of the present invention to provide hands-free use of a interactive recipe and cooking information system utilizing voice activation.

It is yet a further object of the present invention to provide a interactive recipe and cooking information system with user preferences defined within a user database, such that information provided to a user as a result of a user information search is filtered based upon preexisting user preferences.

It is yet a further embodiment of the present invention to provide a interactive recipe and cooking information system that provides recipe and cooking information for multiple recipes simultaneously.

According to the present invention, the means of providing interactive recipe and cooking information is provided in a device designed for user interface either through manual control, such as an integrated keyboard or touch-screen. In one embodiment, the invention provides a speaker so that instructions and information may be provided to the user without the user having to read information on a provided screen at the same time as preparing food. In another embodiment, the invention provides voice activated control for hands-free operation. The recipe and cooking information database are provided within computer-readable medium in the device. The device further comprises electronic storage medium, such as a hard drive, for the storage of the information database, software, user data, and other electronic information. The information database may be periodically updated, either through computer-readable interface with portable electronic storage media such as floppy discs, CDs, DVDs, memory cards, memory sticks, flash drives, and the like. The portable electronic storage media may further include portable electronic devices with data storage and transfer capabilities, such as cellular telephones, personal music and video devices, personal data assistants, and the like. The information database may also be updated by connection, either wired or wirelessly, through personal and/or home computer systems, wireless access points, and the like. While the updates to the database may be made on demand, the invention may alternatively provide periodic updates for the information database through non-static information sources such as interactive world wide web communication.

The recipe and cooking information database is accessed by a computer system which is equipped with a user interface in the form of a keypad, keyboard, touch screen and the like, but the computer system and database may also be accessed through voice recognition means, including a microphone and voice activation software. It will be understood by those skilled in the art that a microphone may be provided within the device itself or may be provided through a headset, wireless communication with a user's cellular telephone or other portable electronic communication device and the like. The device may be connected to existing portable electronic communication devices through the use of common means, such as the current Bluetooth® technology or the like.

The present invention is also provided with a display and speaker or remote speaker so that the information may be provided to the user either through visual or auditory feedback, or a combination of the two. The display is preferentially provided as a touch screen that may be utilized as a user interface, but it will be understood that various combinations of available interface means may be provided in multiple configurations. It will also be understood that the present invention may be configured to utilize the communication capabilities of existing devices, such as cellular telephones.

The device is operated through the available interface means, and provides a user with the opportunity to personalize the interface and feedback, such as by choosing voice or audio feedback, or both. As the information provided may also comprise video information, the device may utilize both visual and audio simultaneously. The user is given a choice of language, with the device preferentially accommodating numerous commonly spoken and written languages, such as English, Spanish, French, etc.

The device further provides means for creating a user profile that will store within a user database information particular to a specific user. For example, the user creates a profile with specific dietary restrictions, which is then stored within the user database in the device. As information queries are made of the database, results are returned that conform to the stored profile information for a particular user.

Once a user has accessed the system, the user enters specific information related to a search for recipes. In response to a user query, the system accesses the database for matches between user's query and recipe information within the database. The results of the search may be filtered using the user's personalized profile, and may also provide numerous possible options for recipes based upon the entered search criteria. The system provides the user with the option of following links, either through manual or voice activated interface, to the detailed information provided for the user based upon the user's search criteria. The user may choose to have the specific recipe information provided through any of the available feedback methods, such as visual or audio. Specific instructions are then provided to the user for preparation of the requested meal. The specific instructions may be displayed and scrolled through in a manual fashion, or the user may choose to have the system provide continuous prompts to the user showing preparation and cooking instructions based upon selected time intervals for the prompts.

It will be clear to those skilled in the art that the present invention may, in addition to being utilized on a stand-alone dedicated system, be utilized on a computer system such as a desktop or laptop personal computer, as well as being utilized on other portable computing devices, such as personal data assistants and cellular telephones. The examples herein are intended to be merely suggestive of the system as embodied in a dedicated computer structure, but should not be considered to limit the present invention to being embodied only in such a dedicated system.

### BRIEF DESCRIPTION OF THE DRAWINGS

FIG. 1 is a diagram of the overall operation of the present invention;

FIG. 2 is a detailed diagram of an operation for creating a user interface/profile;

FIG. 3 is a detailed diagram of an operation for choosing a meal;

FIG. 4 is a detailed diagram of an operation for choosing a meal utilizing existing ingredients;

FIG. 5 is a detailed diagram of an operation for a cooking process.

### DETAILED DESCRIPTION OF A PREFERRED EMBODIMENT

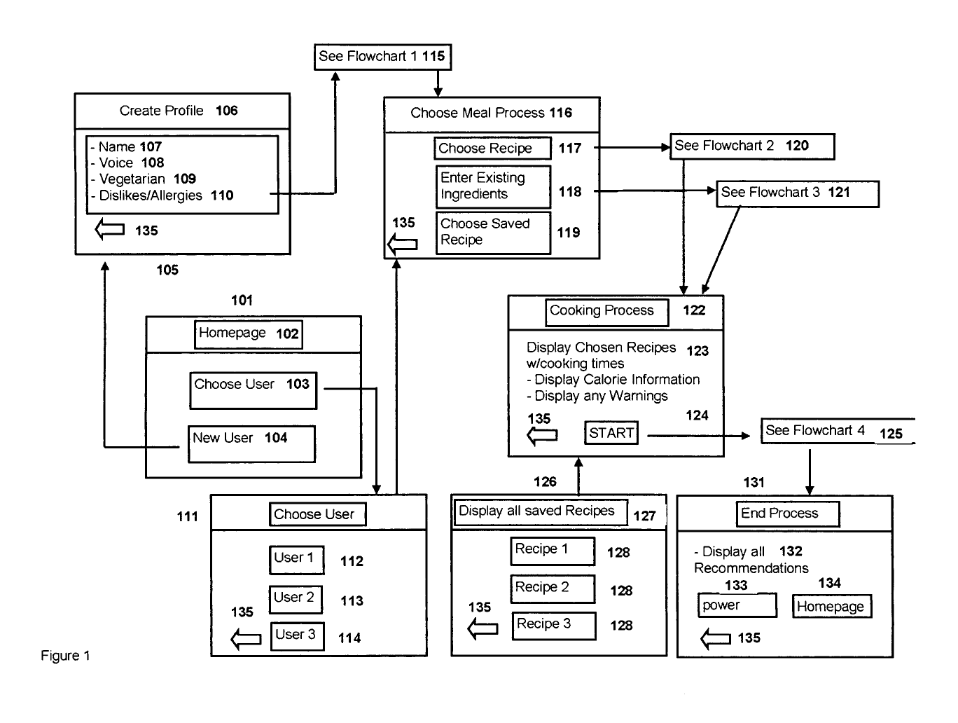

Referring now to FIG. 1, an overall process for the operation of the present invention is shown. A user, upon startup of the system, is provided a display 101 showing the homepage 102 of the system wherein the user may choose user 103 from an existing list of saved user profiles or select new user 104 to create a new user profile or to search under a particular set of criteria that may or may not match existing user profiles. By choosing new user 104, the user is redirected to the Create Profile menu 105. The user is prompted to provide name 107, voice preferences 108 for utilizing the system using either voice or other interface, dietary preferences such as vegetarian 109, and other preferences such as dislikes/allergies 110. The dislikes/allergies preferentially also allows the user to define medically—or other related dietary restrictions, food preferences based upon cultural cuisine preferences, geographic cuisine preferences, and taste preferences, as well as preferences related to such dietary choices as low-carbohydrate food combinations, etc.

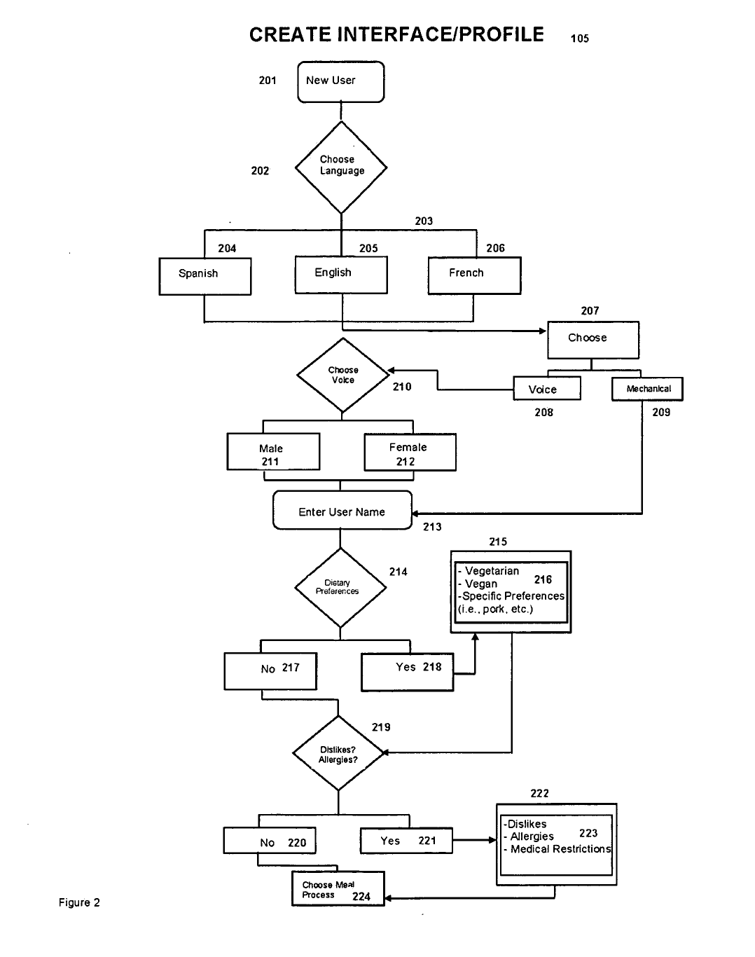

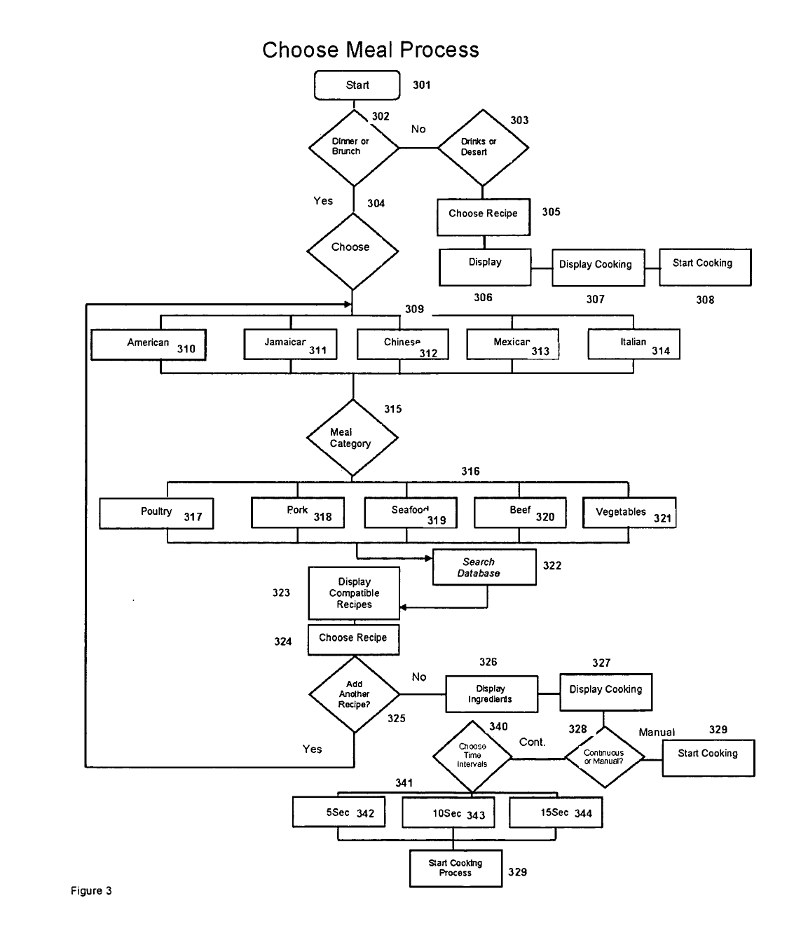

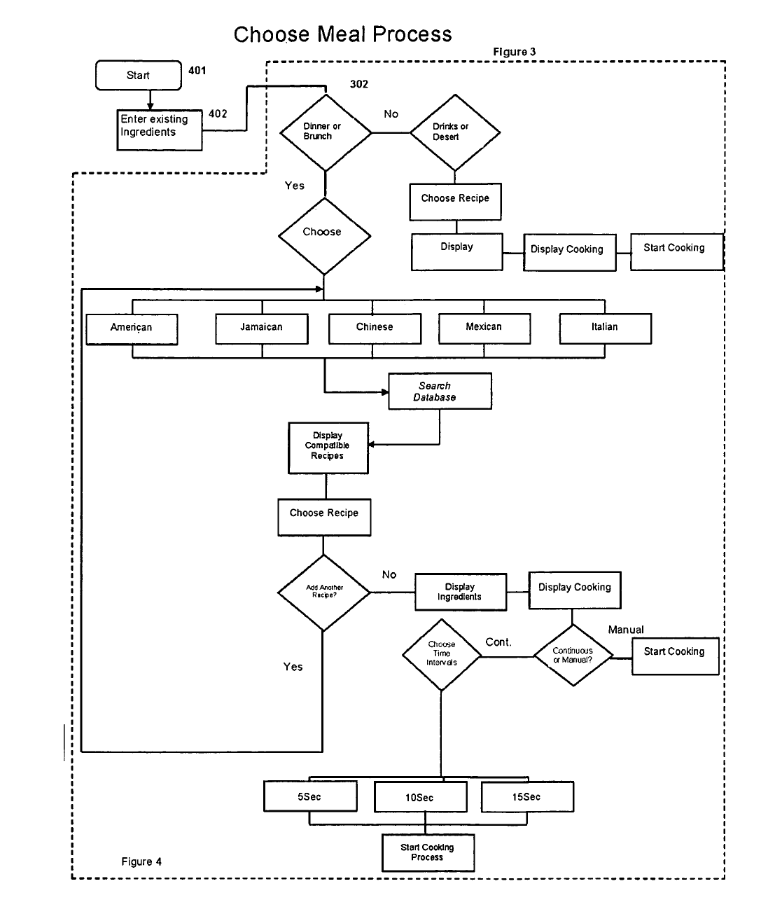

The create profile process is shown in greater detail in FIG. 2. Once the user has created a profile 105, the profile is stored and the user is then directed to the choose meal process main screen 116. At the choose meal step, the user may initiate a database search for an appropriate recipe by choosing an appropriate starting point for the database search process. The starting points are chosen from a set of choose recipe 117, enter existing ingredients 118, or choose saved recipe 119. Upon selecting choose recipe 117, the user is redirected to a first choose meal process 120 (FIG. 3). Upon selecting enter existing ingredients 118, the user is redirected to a second choose meal process 121 (FIG. 4). Upon selecting choose saved recipe 119, the user is redirected to the Display all Saved Recipes menu 127.

The choose recipe 117 function directs the user to a first choose meal process 120 (FIG. 3). Once the user has chosen one or more recipes utilizing the first choose meal process 120, the user is directed to the Cooking Process menu 122.

The enter existing ingredients 118 function directs the user to a second choose meal process 121 (FIG. 4). Once the user has chosen one or more recipes utilizing the second choose meal process 121, the user is directed to the Cooking Process menu 122.

The Display all Saved Recipes menu 126 allows a user to select and retrieve recipes from a plurality of existing recipes 128 that the user has stored in the system database, which allows the user to recreate meals that the user has already searched for and recovered from the database. The existing recipes 128 may be identified by particular names or identifiers chosen by the user, and are displayed 127 in a list within the Display all Saved Recipes menu 126. Once the user has chosen one or more recipes from the existing recipes 128, the user is directed to the Cooking Process menu 122.

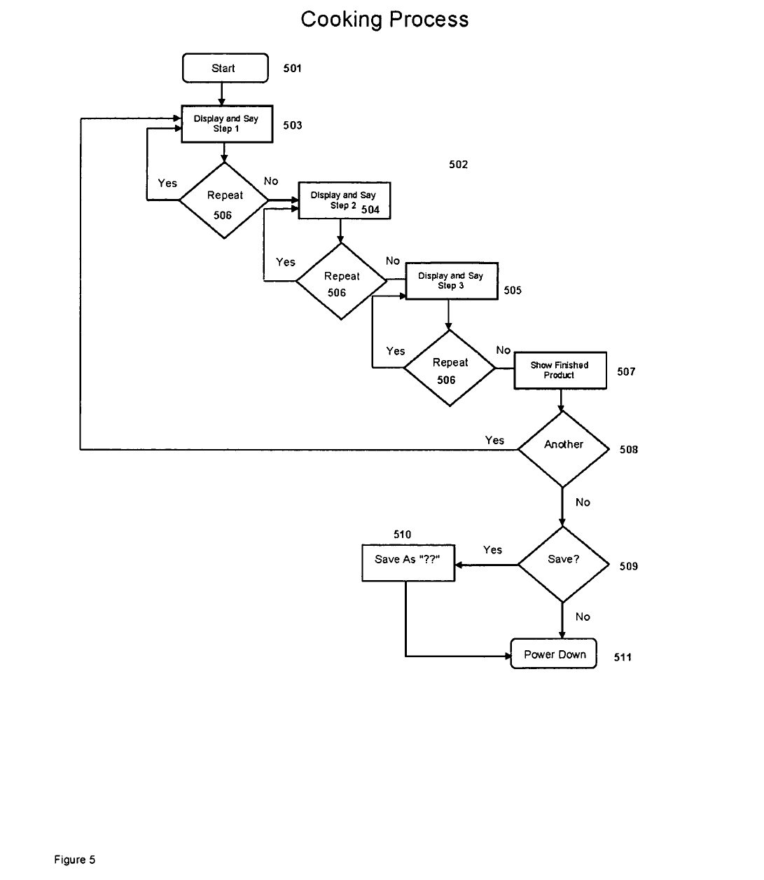

The Cooking Process menu 122 provides the user with cooking process information 123 regarding the particular recipe or recipes chosen by the user. The cooking process information 123 provided may include displaying the chosen recipes, cooking times, calorie and other dietary information, any warnings related to the cooking process such as altitude adjustments and the like, and other information chosen from a group of recipe related adjustments and warnings. It will be understood by those skilled in the art that the group of recipe related adjustments and warnings will vary depending upon ingredients, cooking particulars, and the like. Some examples of adjustment and warning information provided may include ingredient safe preparation and handling methods, safe cooking methods for particular ingredients, warnings related to post-cooking handling such as allowing certain cooked foods to cool prior to moving or handling, or other warnings related to ensuring that the final meal product is safe and as intended. Once the user has been provided the cooking process information 123, the user may then choose to start 124 the cooking process 125, and the user is directed to the cooking process 125 (FIG. 5).

Once the cooking process 125 is completed, the user is directed to the End Process Menu 131. The End Process Menu 131 provides the user with a display of recommendations 132. The user is also provided with an option to power down 133 the system, or return 134 to the homepage for further interaction with the system.

In each sub-menu provided to the user by the system, the user is provided the option to return 135 to the previous menu.

Referring now to FIG. 2, an embodiment of the create interface/profile process 105 is shown. When the user chooses the new user 104 (FIG. 1) option, the user is prompted to choose language 202; the user is prompted to select from a plurality of available language options 203, which may comprise such languages as Spanish 204, English 205, French 206 and the like. It will be understood that these languages are chosen merely for illustration, and the plurality of available language options 203 shown are not intended to be limiting. Once the user has chosen a language from the plurality of available language options 203, the user is then directed to choose interface 207. The user may select from a plurality of interface options, including but not limited to voice 208 and mechanical 209. The set of mechanical 209 options available may include touch-screen, keyboard, mouse, integrated keypad and the like, and the options shown herein are not intended to be limiting.

If the user selects the voice option 208, the user is directed to the choose voice 210 function, wherein the user is provided the option of choosing from a male 211 or female 212 option. The male 211 and female 212 voices may be chosen from a plurality of electronic or mechanically reproduced voices so that the user will have a range of voices available to tailor the interface to the user's individual preferences. Once the user has chosen a voice, the user is then directed to enter a user name 213. If the user selects the mechanical interface option 209, the user is then directed to enter a user name 213.

Upon entry of a user name 213, the user is given the option to determine dietary preferences 214. If the user selects yes 218, the user is directed to a dietary preferences submenu 215, wherein the user may select from a plurality of dietary preferences 216, selected from a group comprising vegetarian, vegan, meat, and a plurality of other dietary preferences to include certain ingredients or styles. It is understood that these dietary preferences 216 are well known in the art, and include numerous ingredient, style, and cooking method instructions (such as including stir fry methods or certain oils). Upon completion of choosing dietary preferences 216, the user is directed to the option of choosing to exclude 219 recipes from the search results based upon certain criteria such as dislikes or particular food allergies. If the user selects “no” 217 to choose dietary preferences 216, the user is similarly directed to the option of choosing to exclude 219 recipes from the search results.

As with the dietary preferences 216, the criteria for exclusion based upon dislikes and allergies are well known in the art, and may include such things as a dislike of certain meats or vegetables, an allergy to peanuts or egg products, and the like. Upon selecting “yes” 221 to modify the database search based upon a user's dislikes or allergies, the user is directed to a submenu 222 wherein the user may choose dislikes/allergies criteria 223 to exclude from the database search. Once the user has finished choosing from a set of dislikes/allergies criteria 223, the user is directed to a choose meal process 224. Similarly, if the user selects “no” 220 to exclude 219 recipes from the database search based upon dislikes/allergies criteria 223, the user is directed to a choose meal process 224 (FIG. 1, 116).

As shown in FIG. 1, from the Choose Meal Process menu 116, a user may select from choose recipe 117, which allows the user to search the recipe database without specifying particular limiting ingredients, or enter existing ingredients 118, which allows the user to search the recipe database for recipes that require or include particular ingredients.

Referring now to FIG. 3, a first choose meal process is shown wherein the user has selected to choose recipe (FIG. 1, 117) without selecting to enter existing ingredients (FIG. 1, 118). At start 301 of the choose meal process, the user is prompted to indicate if they would like to choose from a plurality of a particular meal types 302, such as dinner or brunch. It will be understood that the particular meal type 302 may be chosen from a plurality of meal types common in the art, and the particular meal type 302 shown herein is merely illustrative, and should not be construed as being limiting. Once the user has chosen yes 304 to choose a particular meal type 302, the user is directed to a choose type of meal menu 309. Within the choose type of meal menu 309, the user may select from a plurality of meal types, such as American 310, Jamaican 311, Chinese 312, Mexican 313, Italian 314, and the like. It will be understood that the plurality of meal types described herein are for illustrative purposes only, and should not be construed as limiting.

If the user selects not to choose a particular meal type 304, the user is directed to choose particular drinks or dessert 303. The user then chooses a particular recipe 305 from the database, and the system provides a display of ingredients 306, as well as a display of cooking times 307. The user is then prompted to start cooking 308.

When the user selects from the plurality of meal types in the choose type of meal menu 309, the user may then select a particular meal category 315 from a menu of meal categories 316. The meal category menu 316 provides a plurality of meal category options, such as those based upon particular base ingredients, which may include poultry 317, pork 318, seafood 319, beef 320, or vegetables 321. The plurality of meal categories shown herein is merely illustrative, and should not be construed as limiting.

Once the user has selected a meal category 315 from the meal category menu 316, the database is searched 322 for those recipes that correspond the user's search criteria. Recipes that are compatible with the search parameters are shown as a display compatible recipes menu 323, and the user then chooses 324 from the compatible recipes. The user is then prompted to add another recipe 325. Should the user elect to add another recipe, the user is redirected to choose a particular meal type 304. If the user elects not to add another recipe, the system then shows the display ingredients information 326, as well as the display cooking times 327. From there, the user may choose 328 a continuous or manual cooking process. If the user chooses the manual cooking process, the system prompts 329 the user to start the cooking process.

If the user chooses for the system to display a continuous cooking process, the user may choose from a plurality of time intervals 340, such as 5 second 342, 10 second 343, or 15 second intervals for system prompts related to the cooking process. The time intervals shown herein are merely illustrative, and should not be construed as limiting. Once the user has selected a desired time interval, the user is prompted to start cooking process 329, which will prompt the system to begin displaying the appropriate preparation and cooking information based upon the selected time intervals.

Referring now to FIG. 4, a second choose meal process is shown wherein, at start 401, the user may select to enter existing ingredients 402. Those existing ingredients 402 may correspond to a particular desired selection of ingredients, or may correspond to those ingredients that the user has available. This function allows the user to tailor the database search and results to those ingredients that are available, thereby narrowing the results only to those recipes that the user can apply at the time. Once the user has provided the existing ingredients information, the user is then prompted to start 301 the choose meal process shown in FIG. 3.

Referring now the FIG. 5, a cooking process is shown whereby a user is prompted through the cooking process steps 502 for a particular chosen recipe. The cooking process steps 502 are preferentially communicated to the user through both a visual display and an audio prompt for each particular step in the cooking process. The cooking process steps 502 will progress through each individual sequential step necessary. For example, the system will prompt for step one 503, step two 504, and step three 505 for a chosen recipe consisting of three process steps 502. At each process step 502 prompt, the user is queried 506 whether the user wishes the system to repeat the process step 502. If the user needs to have the information repeated, the user chooses yes, and the system restarts at the beginning of the process step 502. If the user chooses not to have the process step 502 repeated, the system then proceeds to the display and audio prompt for the next process step. This process is repeated until all of the process steps 502 for a particular chosen recipe are completed. At the repeat query 506 for the final step of the cooking process, the finished product is shown 507. It will be understood that the number of cooking process steps 502 will vary depending upon the recipe chosen by the user, and the steps shown herein are merely illustrative. The user is then queried as to whether the user wishes to have the system show the cooking process for another recipe. If the user prompts the system to show the cooking process for another recipe, the system starts the cooking process at step one for the newly chosen recipe. If the user chooses not to have the system show the cooking process for another recipe, the user is queried whether or not the user wants to save 509 the particular recipe. If yes, the user enters a recipe name 510 under which the system saves the recipe in the database. If the user chooses not to save the recipe, the system powers down 511.

The invention herein has been described in a manner that is illustrative only, and it will be apparent to one skilled in the art that there are modifications and alterations to the present invention that will not deviate from the scope and spirit of the invention as disclosed herein.

I claim:

1. An apparatus for providing information in compliance with a desired result, the apparatus comprising:
(a) a first database comprising searchable information;
(b) a second database comprising search criteria;
(c) a third database comprising data results;
(d) a user interface means responsive to operator inputs for defining the search criteria stored in the second database;
(e) an application program executable by a computer, the application program adapted to search within the first database, the application program searching in conformity with the search criteria of the second database for generating the data results stored in the third database;
(f) one or more memory means for storing the first database, the second database, the third database, and the application program; and
(g) an output means communicating the data results to a user.

2. The apparatus of claim 1, wherein the memory means is a portable electronic storage medium.

3. The apparatus of claim 1, wherein the search criteria is user generated.

4. The apparatus of claim 1, further comprising means to store user-related information.

5. The apparatus of claim 4, wherein the search criteria is generated from stored user-related information.

6. The apparatus of claim 1, wherein the first database containing searchable information comprises formulas chosen from the group consisting of food recipes, beverage recipes, ingredient information, and related chemical combinations.

7. The apparatus of claim 1, wherein the search criteria generated by user inputs are chosen from the group comprising food preferences, food allergies, drink preferences, medically-related dietary restrictions, cultural cuisine preferences, geographic cuisine preferences, and taste preferences.

8. The apparatus of claim 4, wherein the beverage preferences are chosen from the group comprising user selected type, style and texture of beverages.

9. The apparatus of claim 1, wherein the second database further comprises search criteria chosen from the group comprising dietary ingredients and beverage ingredients, geographic and cultural preferences, food preferences, food allergies, beverage preferences, medically-related dietary restrictions, cultural cuisine preferences, geographic cuisine preferences, and taste preferences.

10. The apparatus of claim 1, further comprising computer interface means to update the searchable information contained with the first database.

11. The apparatus of claim 7, wherein the computer interface means is compatible with memory means chosen from the group comprising a floppy disc, compact disc, DVD, memory card, memory stick, flash drive, cellular telephone, portable data assistant, personal music device, video device, or related portable electronic storage media.

12. The apparatus of claim 7, wherein the means to update the first database is a wired or wireless connection with a personal computer, home computer system or a wireless access point, or interactive world wide web communication.

13. The apparatus of claim 1, wherein the user interface means is selected from the group comprising a keypad, keyboard, a touch screen, or a voice recognition means and wherein the output means is a visual display, a touch screen display, speakers, remote speakers, display and speakers or a combination of a display and remote speakers whereby information is provided to the user by visual feedback or auditory feedback, or a combination of the two.

14. The apparatus of claim 10, wherein the voice recognition means further comprises integrated voice activation software, at least one microphone and at least one speaker.

15. The apparatus of claim 1, further comprising means for a user to select the user interface means from a group comprising vocal input, auditory output, visual output, or a combination thereof.

16. The apparatus of claim 1, wherein the application program is further adapted to create and store a user profile information.

17. The apparatus of claim 13, wherein the user profile information is chosen from the group comprising selected starting materials, dietary ingredients and beverage ingredients, geographic and cultural preferences, food preferences, food allergies, beverage preferences, medically-related dietary restrictions, cultural cuisine preferences, geographic cuisine preferences, and taste preferences.

18. The apparatus of claim 1, wherein data results selected by the user further comprise a process description whereby the application program coupled with the output means communicate the process description to the user.

19. A method for providing information in compliance with a desired result which comprises:
(a) providing a first database containing searchable information;
(b) providing a second database comprising search criteria generated by user inputs;
(c) defining the search criteria stored in the second database;
(d) executing an executable application program adapted to search within the first database, the application program searching in conformity with the search criteria of the second database for generating the data results stored in the third database, the application program further adapted to compile and generate search results, communicate the search results to and output, and store the search results;
(e) searching the first database for information in conformity with the search criteria of the second database;
(f) generating information results of the search within the first database for identifying information results in conformity with the search criteria of the second database, and;
(g) communicating the information results to a user.

20. The method of claim 19, further comprising the step of storing the first database information, second database information, and third database information on one or more memory means.

21. The method of claim 19, wherein the first database further comprises formulas chosen from the group consisting of food recipes, beverage recipes, ingredient information, and related chemical combinations.

22. The method of claim 19, wherein the dietary information is chosen from the group consisting of food style, dietary preference, food allergies, mixed drink preferences and medical restrictions.

23. The method of claim 19, wherein the search criteria generated by user inputs further comprise starting materials chosen from the group consisting of dietary ingredients and mixed drink ingredients.

24. The method of claim 23, wherein the mixed drink preferences are chosen from the group comprising type, style and texture of mixed drinks.

25. The method of claim 19, wherein the second database further comprises a user profile.

26. The method of claim 25, wherein the user profile further comprises user selected information.

27. The method of claim 26, wherein the user selected information comprises the choice of language, interface, dietary preferences, allergies, starting ingredients and medical restrictions.

28. The method of claim 19, further comprising the step of selecting desired result from the information results.

29. The method of claim 28, further comprising the step of communicating the desired results to a user.
